(19) United States
(12) Patent Application Publication
(10) Pub. No.: US 2009/0101119 A1
(43) Pub. Date: Apr. 23, 2009

(54) CARBON CANISTER CAP WITH INTEGRATED DEVICE

(75) Inventor: Stephan Ammermann, Gottingen (DE)

Correspondence Address: HARNESS, DICKEY & PIERCE, P.L.C., P.O. BOX 828, BLOOMFIELD HILLS, MI, 48303, US

(73) Assignee: A. Kayser Automotive Systems, GmbH, a German corporation, Einbeck (DE)

(21) Appl. No.: 12/328,908

(22) Filed: Dec. 5, 2008

Related U.S. Application Data
(63) Continuation-in-part of application No. 11/716,872, filed on Mar. 12, 2007, now abandoned.
(60) Provisional application No. 60/992,431, filed on Dec. 5, 2007.

(51) Int. Cl. F02M 33/02

(52) U.S. Cl. 123/519

(57) ABSTRACT

A carbon canister filter box having an integrated cap. The integrated cap incorporates one or more components, such as vent solenoids, pressure sensors, an internal honeycomb feature for assisting in trapping hydrocarbons from the fuel vapor, and purge ports. The integrated cap sealingly attaches to a carbon canister vapor recovery system and can be manufactured to be implemented on existing canister units. The cap connects to the automotive emission storage canister in relation to the fuel tank of the vehicle, used to recapture fuel vapor before it is released into the atmosphere. A sealing means is positioned between the cap and the canister, preventing the leakage of fuel vapor into the outside atmosphere.

### CROSS-REFERENCE TO RELATED APPLICATIONS

This application is a continuation-in-part of U.S. patent application Ser. No. 11/716,872 filed on Mar. 12, 2008. This application claims the benefit of U.S. Provisional Application No. 60/992,431, filed on Dec. 5, 2007.

### FIELD

The present disclosure relates to emission control devices for vehicles. More particularly, the present disclosure relates to a carbon canister with integrated emission devices such as filters, solenoids, and/or other sensors connected to the fuel storage unit of an automobile.

### BACKGROUND

The statements in this section merely provide background information related to the present disclosure and may not constitute prior art.

Canisters for storing emissions are provided on automotive vehicles to prevent the discharge of fuel vapors outside vehicles during refueling or normal operation. Often referred to as onboard refueling vapor recovery (ORVR), the typical canister contains activated carbon and is mounted within a vehicle in communication, via a first or vapor inlet port, with the headspace in the fuel tank; via a second or vapor outlet port, with a vacuum source in the engine intake manifold; and via a third or vent port, with the atmosphere outside the vehicle. During refueling, the fill pipe is sealed against vapor leakage, either by a flexible gasket surrounding the fill nozzle or by a liquid seal in the fill pipe. As the tank is filled, air and vapors in the headspace above the fuel are forced through the vapor inlet port into the canister. The vapors are adsorbed onto the charcoal bed, and the air is discharged through the vent port. During subsequent operation of the vehicle, the engine vacuum draws air through the vent port, gradually purging the adsorbed vapors via the vapor outlet port into the engine's combustion flow and preparing the canister for the next refueling. Air also flows back through the vent port into the fuel tank, as needed, to replace fuel being consumed by the engine.

The air vent port is normally open during periods of non-operation of the vehicle. Fuel tank vapors must be adsorbed by the canister before reaching the vent port. This function is known in the art as diurnal adsorption. Such diurnally adsorbed fuel is also desorbed and conveyed by vacuum to the engine upon startup.

Federal regulations require that each vehicle be equipped to conduct an onboard diagnostic (OBD) leak test of the evaporative emissions system. Several manufacturers use a vacuum decay OBD which requires an apparatus for closing off the vapor outlet and vent ports, the vapor inlet port being effectively sealed during testing by the fuel tank cap.

Typically, an ORVR canister is mounted immediately adjacent the fuel tank to minimize vapor flow restriction into the canister. Since the fuel tank commonly is located near the rear of the vehicle and the engine at the front, a relatively long hose run is required to connect the canister to the engine intake. A first electric solenoid valve at the canister can close the canister vent port, and a second solenoid valve at the engine can close the vapor outlet line. To test the system for leaks, first the vent port is closed, exposing the system to full engine vacuum, and then the outlet line is closed. The OBD system monitors the rate of decay of the captured vacuum.

Mounting the canister at the rear of the vehicle exposes the vent port to dust and debris which, if allowed to enter the canister, can foul the vent solenoid and internal passages, gradually clogging the solenoid valve and the canister and causing failure of the seal test. Entry of dust and debris can also cause operational problems with refueling of the vehicle, including failure to fill properly and premature shutoffs of the refueling nozzle. To prevent such entry, U.S. Pat. No. 5,878,729, issued Mar. 9, 1999 to Covert et al. ('729) and incorporated herein by reference, discloses a canister providing two separate vent ports—an outlet vent port with a check valve for releasing fuel tank air during refueling and an inlet vent port connected to the downstream side of the engine air filter. An additional check valve is disposed between the inlet vent port and the engine to prevent vapors flowing into the air cleaner during refueling and causing an over-rich fuel/air mixture being fed to the engine at startup.

U.S. Pat. No. 6,390,073, issued May 21, 2002 to Meiller et al. ('073), discloses an onboard vapor recovery canister which utilizes a solenoid valve in association with a filter means, but requires being attached to the fuel system as a single assembly. Furthermore, the '073 patent operates only with a foam filter and carbon absorption bed. Eventually, a higher pressure drop increase can result after prolonged use of the canister, which can often cause early shutoff of a refueling pump nozzle due to backed up fuel vapors in the fuel tank.

Often it is desirous for the vapor recovery systems to be associated with various other emission control devices, such as vent solenoids, pressure sensors, and purge ports, which increase the efficiency and longevity of the systems. By incorporating theses additional devices within a single unit, which may be retrofitted on existing carbon canisters, the costs of manufacturing, assembly, and installation are greatly minimized.

### SUMMARY

The present disclosure overcomes the above shortcomings in the art, comprising a carbon canister filter box having an integrated cap. The integrated cap contains one or more components, such as a vent solenoid, a filter, a pressure sensor, an internal feature for assisting in trapping dust, and purge ports. The integrated cap attaches to a carbon canister vapor recovery system and can be designed to be implemented on existing manufactured units. The cap connects to the automotive emission storage canister in relation to the fuel tank of the vehicle, used to recapture fuel vapor before it is released into the atmosphere. A closed cell foam or rubber O-ring provides a sealing between the integrated cap and the filter housing.

It is therefore an object of the present disclosure to provide an integrated cap for a carbon canister fuel vapor recovery system of vehicles comprising a plurality of emission control functions in a single unit.

It is a further object of the present disclosure to provide an integrated cap for use in conjunction with a canister as herein described which is economical to manufacture.

Another object of the present disclosure is to provide an integrated cap for a carbon canister which provides a universal fit to a plurality of canisters equipped on various vehicles.

Another object of the present disclosure is to provide an integrated cap for a carbon canister which integrates a feature utilized to trap dust particles.

Another object of the present disclosure is to provide an integrated cap for a carbon canister which integrates a vent solenoid.

Another object of the present disclosure is to provide an integrated cap for a carbon canister which integrates a pressure sensor, utilized in conjunction with the vehicle emissions control system.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective exploded view of the carbon canister, integrated cap, and various emission components associated therein;

FIG. 2A is an assembled, first side view of the carbon canister and integrated cap of FIG. 1;

FIG. 2B is an assembled, second side view of the carbon canister and integrated cap illustrated in FIG. 1;

FIG. 3 is an assembled, first end view of the carbon canister and integrated cap illustrated in FIG. 1;

FIG. 4 is an assembled, second end view of the carbon canister and integrated cap illustrated in FIG. 1;

FIG. 5 is an assembled, overhead view of the carbon canister and integrated cap illustrated in FIG. 1;

FIG. 6 is a cross-sectional, split illustration of the carbon canister and integrated cap of FIG. 1;

FIG. 7 is a side view of a vapor storage canister having an integral filter box;

FIG. 8 is a side view of the vapor storage canister having an integral filter box separated;

FIG. 9 is a first cross sectional view of the vapor storage canister having the integral filter box attached;

FIG. 10 is a perspective exploded view of the components comprising the integral filter box of the present disclosure;

FIG. 11A is first side view of the integral filter box of the present disclosure;

FIG. 11B is a second side view of the integral filter box of the present disclosure;

FIG. 11C is a first end view of the integral filter box of the present disclosure, illustrating the outlet to attach to a canister;

FIG. 11D is a third side view of the integral filter box of the present disclosure;

FIG. 11E is a second end view of the integral filter box of the present disclosure, illustrating the atmospheric port;

FIG. 12 is a fourth side view of the integral filter box of the present disclosure;

FIG. 12A is a cross sectional view of FIG. 12 taken along line 12A;

FIG. 12B is a cross sectional view of FIG. 12 taken along line 12B;

FIG. 13 is the first side view of the integral filter box of the present disclosure;

FIG. 13A is a cross sectional view of FIG. 13 taken along line 13A; and

FIG. 13B is a cross sectional view of FIG. 13 taken along line 13B.

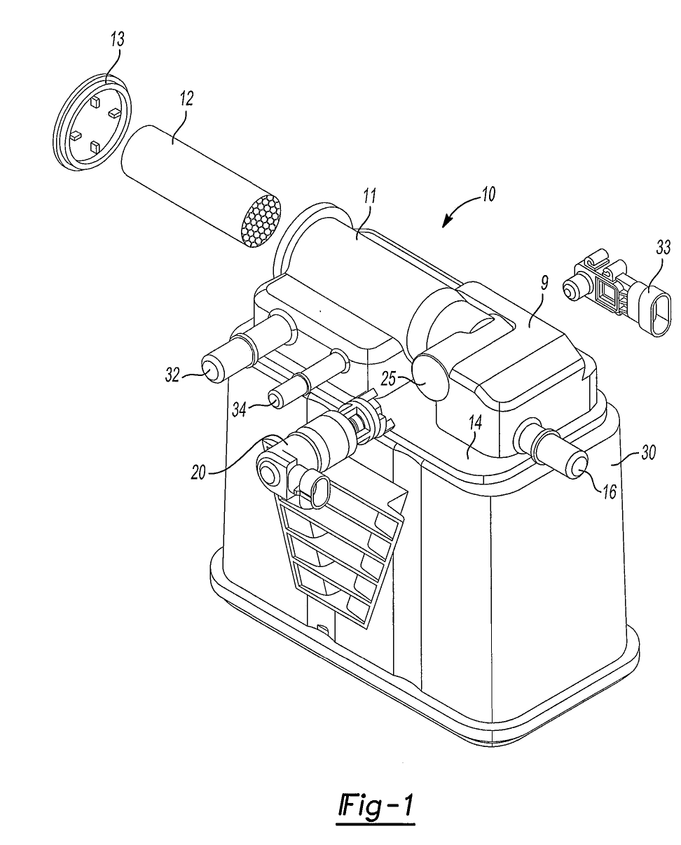

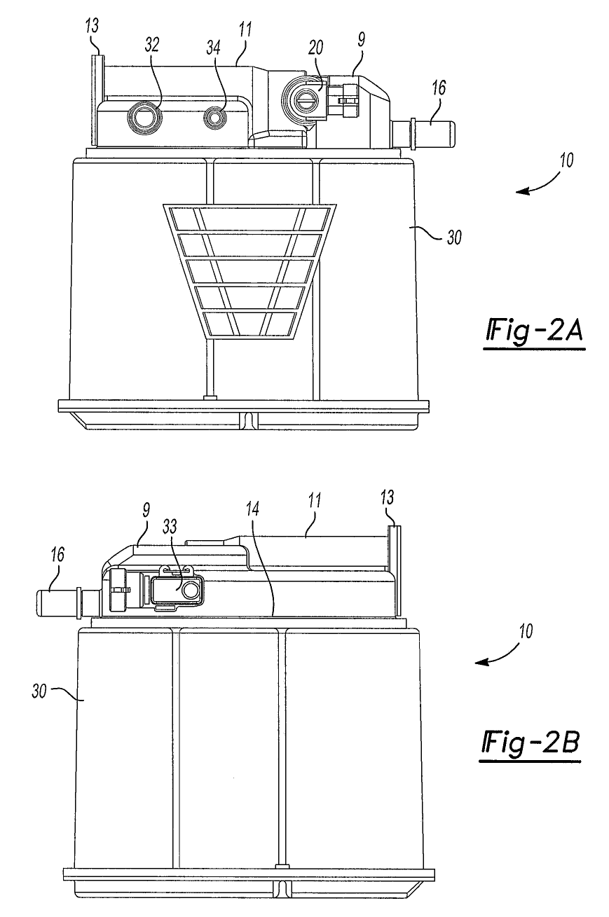

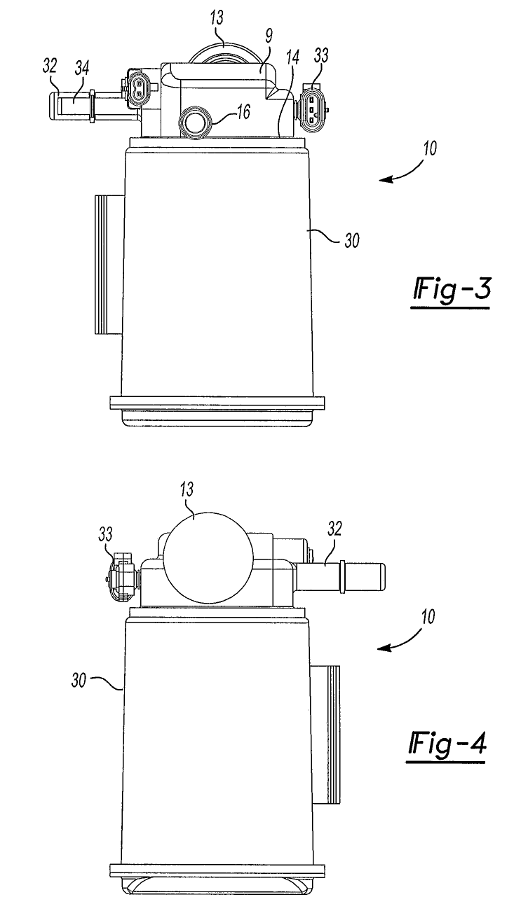

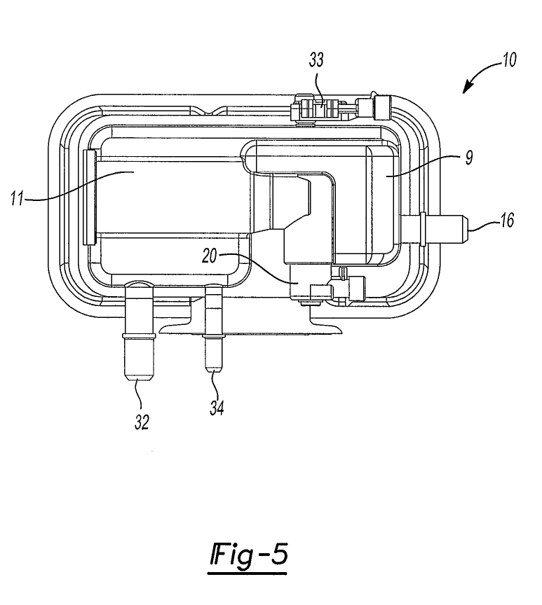

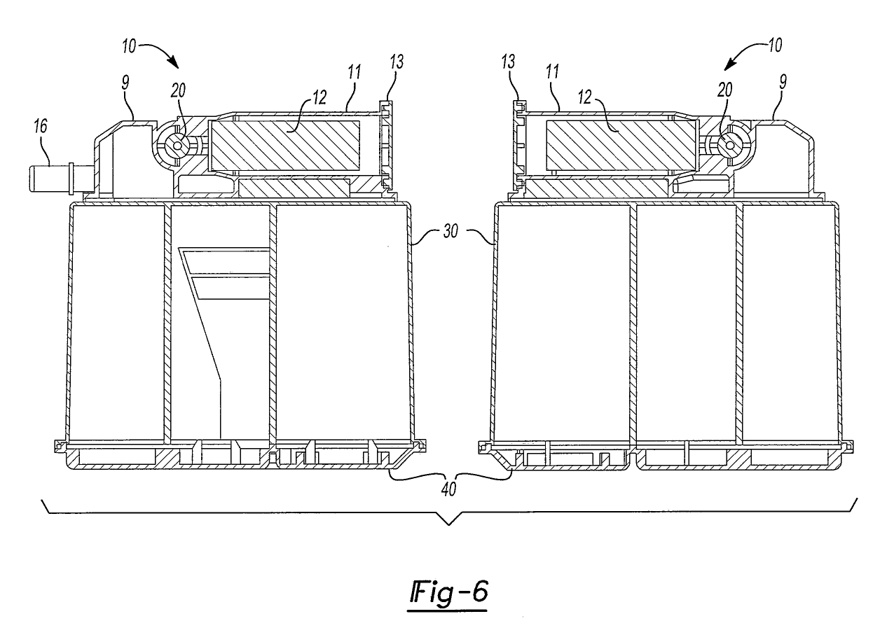

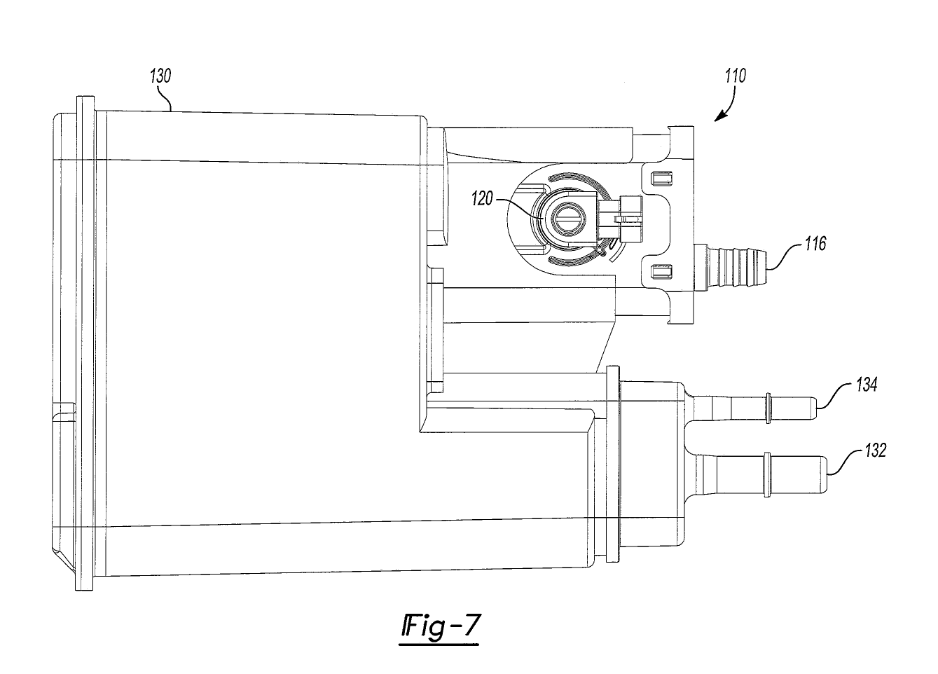

### DESCRIPTION

The following description is merely exemplary in nature and is not intended to limit the present disclosure, application, or uses. It should be understood that, throughout the drawings, corresponding reference numerals indicate like or corresponding parts and features.

Referring now to the figures, a preferred embodiment of the present invention is shown comprising an integrated cap 10 attached to a housing of a vapor storage canister 30 of an automotive fuel vapor recovery system. The vapor storage canister 30 as mentioned is placed at the end of the vent system of a gasoline fuel tank on a vehicle. The vapor storage canister 30 adsorbs (buffers) the fuel vapors that are released from the fuel tank and enter the canister through the tank port 32 during normal operating or during refueling of the tank. From time to time, the vapor storage canister 30 is purged with clean air via purge port 34, wherein clean air is drawn in through the vapor storage canister 30 from an atmospheric port 16, desorbing the fuel vapors and transporting them to the combustion air of the engine through purge port 34.

The integrated cap 10 comprises an attachment portion 14 for attaching integrated cap 10 to vapor storage canister 30 by welding or any other process known in the art. The attachment of integrated cap 10 to vapor storage canister 30 creates a seal between these components. The integrated cap also includes a first end portion 11 which contains a filter having a honeycomb feature 12. The honeycomb feature of filter 12 is a charcoal cylinder having an internal honeycomb structure, which captures very fine hydrocarbon molecules emitted through the tank port 32 of the cap. The honeycomb feature of filter 12 is integrated into the cap 10 which can be used alone or in conjunction with a foam filter element. A cover lid 13 is attached to the cap 10, retaining the honeycomb feature 12 inside. The opposing end 9 of the cap 10 comprises a lateral aperture 25 for receiving a vent solenoid valve 20 there within. The vent solenoid valve 20 seals the fuel tank during the OBD-II testing to check for possible leaks in the complete fuel system. To protect the vent solenoid valve 20 and the canister against dust, especially during the purge process, the vent solenoid valve 20 is integrated into the cap 10.

Proximal the vent solenoid 20, the atmospheric air port 16 is integrated into the cap, allowing atmospheric air within the vapor storage canister 30. Located opposite the vent solenoid valve 20 on the cap 10, a pressure sensor 33 is attached thereto, allowing for remote measurements of the air pressure building within the canister, indicating when maintenance should be performed.

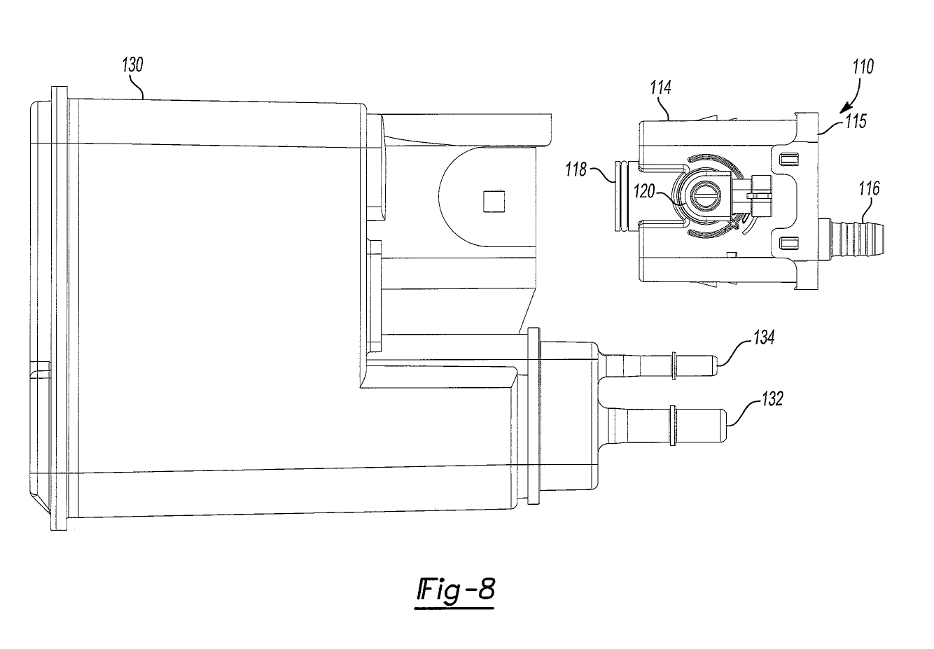

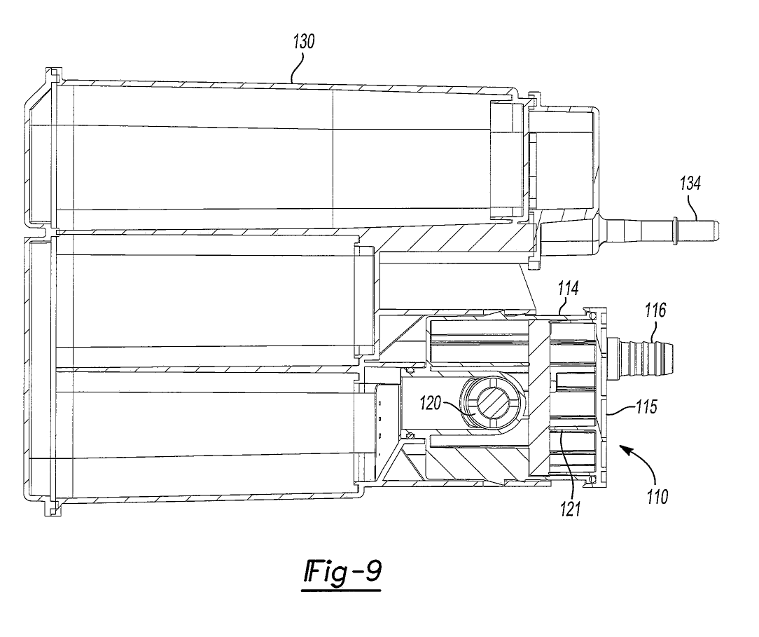

Referring now to FIGS. 7-13, a vapor storage canister 130 in accordance with another embodiment of the disclosure is illustrated. Vapor storage canister 130 includes an integral filter box cap assembly 110 that is releasably attached to vapor storage canister 130.

The vapor storage canister 130 as mentioned is placed at the end of the vent system of a gasoline fuel tank on a vehicle. The vapor storage canister 130 adsorbs (buffers) the fuel vapors that are released from the fuel tank and enter the canister through the tank port 132 during normal operating or during refueling of the tank. From time to time the vapor storage canister 130 is purged with clean air via an atmospheric or purge port 134, wherein clean air is drawn in through the canister from the atmospheric port 116, desorbing the fuel vapors and transporting them to the combustion air of the engine from an engine port.

The filter box cap assembly 110 with integrated vent solenoid valve 120 comprises a main filter box cap 114 and is sealingly attached to the atmospheric port of the vapor storage canister 130 through an outlet 118 as part of the evaporative diagnostic known as OBD-II testing. The electrical operated valve seals the fuel tank during the OBD-II testing to check for possible leaks in the complete fuel system. To protect the vent solenoid and the canister against dust, especially during the purge process, the vent solenoid valve 120 is integrated into the filter box cap assembly 110. A filter box top 115 is sealingly attached to the opposite end of filter box cap 114 and comprises an atmospheric port 116 therein.

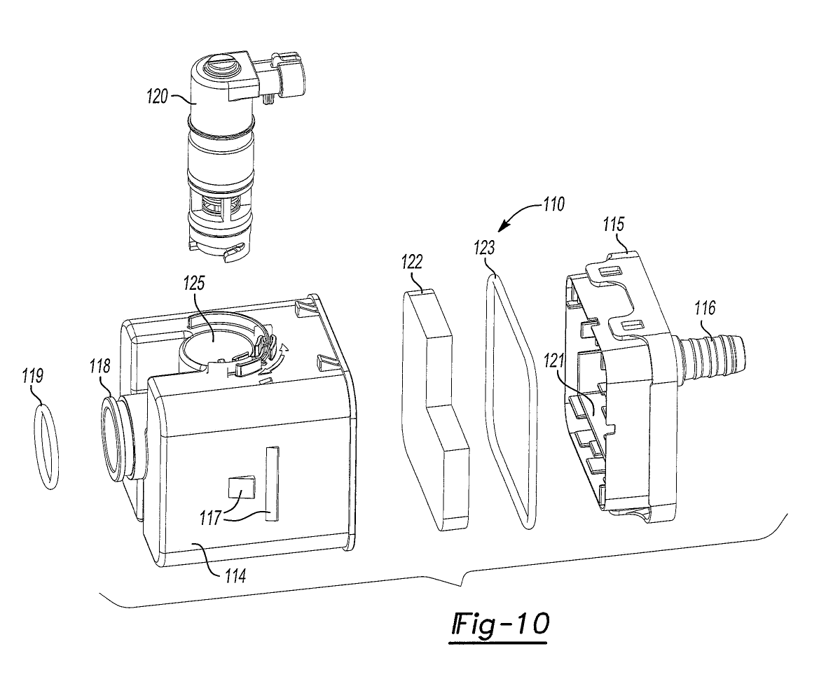

Referring now to FIG. 9, a longitudinal cross-sectional illustration of the filter box cap assembly 110 attached to vapor storage canister 130 is shown. The labyrinth walls 121 of filter box top 115 are apparent in FIG. 9, which provide for a means of separating dust from the gas flow. The advantage of the labyrinth walls 121 is to provide a further filter means (known in the art as a centrifugal-filter) which may be used alone or in combination with a foam filter.

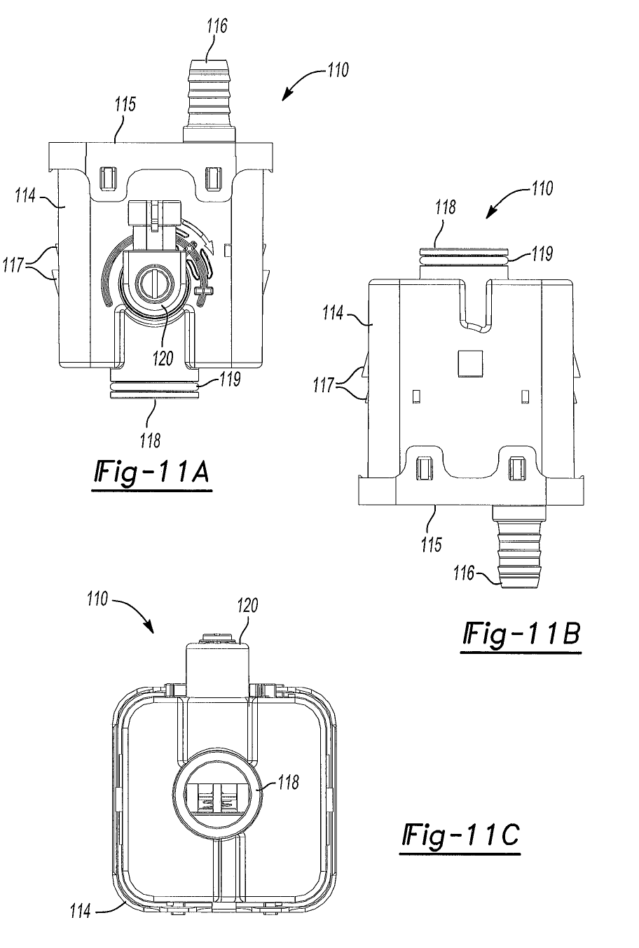

FIG. 10 illustrates an exploded view of the various components comprising the filter box cap assembly 110. The filter box cap 114 comprises outlet 118 at one end for connecting with the vapor storage canister 30 and comprises a grove for retaining a sealing means 119 such as a resilient O-ring. On the top side of the filter box cap 114, an aperture 125 sealingly receives the vent solenoid valve 120 which is locked into place within the filter box cap 114 when assembled. A plurality of locking ramps 117 are integrated in the outside of the filter box cap 114 which secure the housing to the canister as shown in FIG. 9.

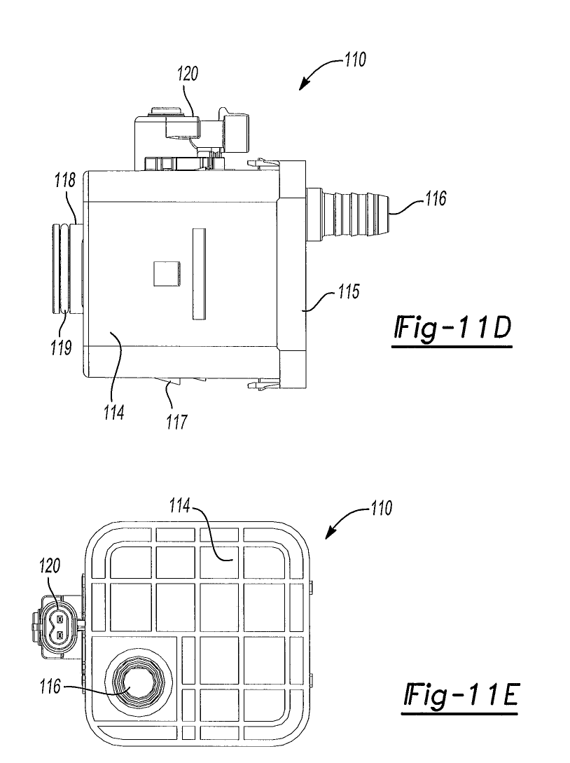

The optional filter foam pad 122 and sealing means 123 are received on the opposite end of the filter box cap 114 from the outlet 118, and are retained in place by filter box top 115 which is detachably attachable to the housing. The filter box top 115 as stated above comprises a series of integrated labyrinth walls 121 which provide a labyrinth-type filtering system for the air which is received through the atmospheric port 116 of the filter box top 115. FIGS. 11A through 11E, show isolated perspective views of the filter box cap assembly 110 from each side and end to further illustrate the design and integrated components described herein.

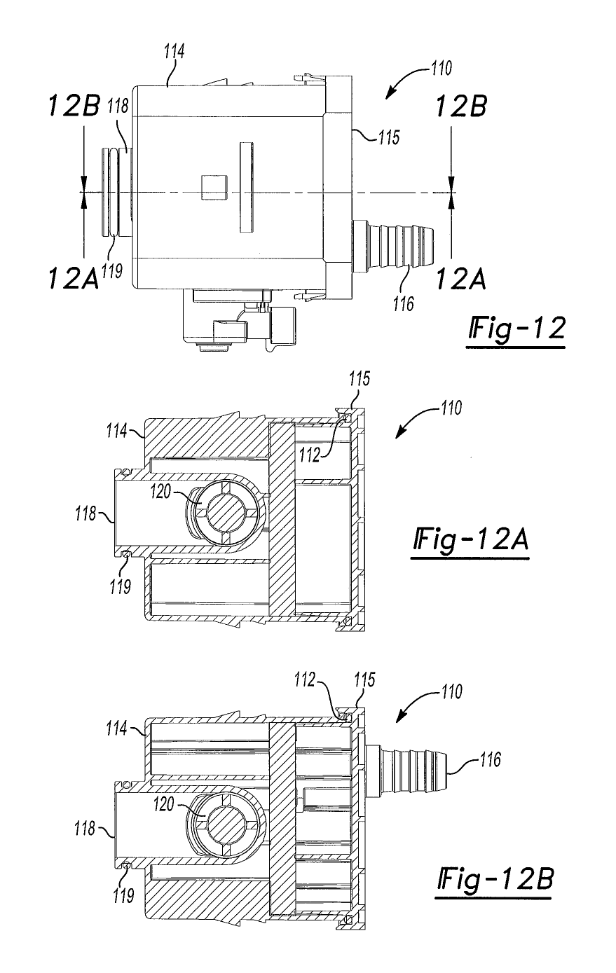

FIGS. 12 through 12B show an isolated, side view of the filter box cap assembly 110, and two cross-sectional views thereof. From these figures, the sealing means utilized to seal the filter box top 115 to the filter box cap 114 comprises an O-ring 112, but it is intended to be within the scope of the present invention that any suitable sealing means known in the art may be implemented. Furthermore, the sealing means 119 around the outlet 118 of the filter box cap 114 also comprises an O-ring and as stated is retained within an annular grove within the outlet 118.

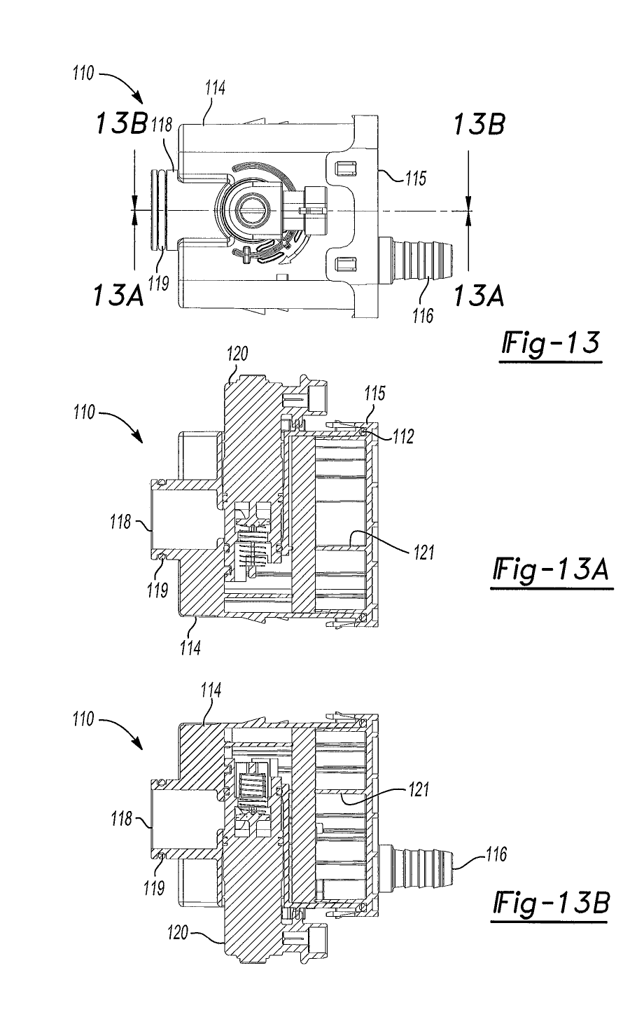

Lastly, FIGS. 13 through 13B show an isolated side view of the filter box cap assembly 110, and two cross-sectional views thereof. From these illustrations, the position and orientation of the vent solenoid valve 120 is shown within filter box cap 114 located between the labyrinth walls 121 of the filter box top 115 and the outlet 118 on the opposite side of the filter box cap 114. The solenoid is sealingly received within the filter box cap 114, preventing air and vapor leakage there around during use.

As noted, providing a cap integrating some or all of the features listed and described herein is advantageous in that the cost of manufacturing multiple components for a fuel vapor recovery system is minimized. Furthermore, the cost of implementation and assembly is also minimized. Lastly, in a preferred embodiment, the caps 10 and 110 are manufactured to fit standard vapor storage canisters 30 already implemented on vehicles, eliminating the need to remanufacture the canister, as well.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vapor storage canister having an atmospheric port, a tank port and a purge port, the vapor storage canister comprising:
a housing defining an internal volume;
a separate cap sealingly attached to the housing;
a filter disposed within the cap; and
a solenoid valve disposed within the cap.

2. The vapor storage canister according to claim 1, further comprising a pressure sensor disposed within the cap.

3. The vapor storage canister according to claim 2, wherein the cap is a single component which defines the atmospheric port, the tank port and the purge port.

4. The vapor storage canister according to claim 1, wherein the cap is a single component which defines the atmospheric port, the tank port and the purge port.

5. The vapor storage canister according to claim 1, wherein the cap comprises:
a filter box cap in direct engagement with an outlet port of the housing; and
a filter box lid sealingly attached to the filter box cap, the filter box lid defining the atmospheric port.

6. The vapor storage canister according to claim 5, wherein the filter box lid defines the filter, the filter comprising a labyrinth defining a centrifugal-filter integral with the filter box lid.

7. The vapor storage canister according to claim 5, further comprising means for detachably attaching the filter box lid to the filter box cap.

8. The vapor storage canister according to claim 1, wherein the filter is a labyrinth defining a centrifugal-filter integrated with the cap.

9. The vapor storage canister according to claim 1, further comprising means for detachably attaching the separate cap to the housing.

10. The vapor storage canister according to claim 1, wherein the filter includes a honeycomb feature.

11. The vapor storage canister according to claim 10, further comprising a pressure sensor disposed within the cap.
